(19) United States
(12) Patent Application Publication
(10) Pub. No.: US 2025/0334944 A1
(43) Pub. Date: Oct. 30, 2025

(54) METHOD AND SYSTEM FOR AUTOMATIC GENERATION OF PLC LOGIC

(71) Applicant: Control in Motion LLC, Troy, MI (US)

(72) Inventor: Franz Holguín Madrigal, Shelby Township, MI (US)

(21) Appl. No.: 18/644,537

(22) Filed: Apr. 24, 2024

(51) Int. Cl. G05B 19/042

(52) U.S. Cl. CPC G05B 19/0426; G05B 2219/13004

(57) ABSTRACT

A computer-implemented method according to an example embodiment of the present disclosure includes receiving programmable logic controller (PLC) configuration data for an industrial process. The PLC configuration data describes a PLC, a plurality of PLC assets, a plurality of PLC devices associated with the plurality of PLC assets, and network connectivity data for communication between the PLC and the PLC assets and PLC devices. The method also includes determining, from a repository of PLC ladder logic templates and based on the PLC configuration data, a set of PLC ladder logic templates that correspond to the plurality of PLC assets and PLC devices; and, based on the PLC configuration data and set of PLC ladder logic templates, creating PLC logic for performance of the industrial process. The PLC logic includes the set of PLC ladder logic templates populated with portions of the PLC configuration data. A system is also disclosed.

### BACKGROUND

This application relates to programmable logic controllers (PLCs), and more particularly to the automatic generation of ladder logic statements for PLCs.

PLCs are used to control machinery for various industrial processes which often utilize robots. PLC is commonly used for manufacturing, food processing, mining, and pharmaceutical processing, for example. PLCs receive inputs, whether from automated data capture points or from human input points such as switches or buttons, and provide outputs based on their programming. A PLC's outputs can control a huge variety of equipment, including motors, solenoid valves, lights, switchgear, safety shut-offs and many others.

A known way to program PLCs is the use of ladder logic software which includes a plurality of “rungs” that are sequentially processed. The rung organization scheme bears some resemblance to a ladder. A rung is processed from left to right, and a typical rung will include one or more conditions, which if satisfied, trigger the execution of one or more steps to the right of the one or more conditions.

Creating ladder logic programming is a cumbersome and tedious process, for even relatively small industrial applications.

### SUMMARY

A computer-implemented method according to an example embodiment of the present disclosure includes receiving programmable logic controller (PLC) configuration data for an industrial process. The PLC configuration data describes a PLC, a plurality of PLC assets, a plurality of PLC devices associated with the plurality of PLC assets, and network connectivity data for communication between the PLC and the PLC assets and PLC devices. The method also includes determining, from a repository of PLC ladder logic templates and based on the PLC configuration data, a set of PLC ladder logic templates that correspond to the plurality of PLC assets and PLC devices; and, based on the PLC configuration data and set of PLC ladder logic templates, creating PLC logic for performance of the industrial process. The PLC logic includes the set of PLC ladder logic templates populated with portions of the PLC configuration data.

In a further embodiment of the foregoing embodiment, the receiving includes providing a table-based interface to a user and receiving the PLC configuration data through the table-based interface.

In a further embodiment of any of the foregoing embodiments, the table-based interface is a spreadsheet interface and providing the table-based interface includes providing the table-based interface through a spreadsheet editor.

In a further embodiment of any of the foregoing embodiments, the plurality of PLC assets includes at least one robot, and the PLC configuration data describes, for each of the at least one robots, an intended function of the robot and a sequence of the intended function in the industrial process.

In a further embodiment of any of the foregoing embodiments, the PLC configuration data includes a description of a plurality of slots of a chassis of the PLC, and, for each slot in a subset of the slots that are not empty, a device present in the slot.

In a further embodiment of any of the foregoing embodiments, the PLC configuration data includes, for each of the plurality of PLC devices, a type of the PLC device, a network address of the PLC device, a name of the PLC device, and an indication of which slot of a chassis of the PLC the network address corresponds to.

In a further embodiment of any of the foregoing embodiments, the PLC configuration data includes a description of an allocation of at least a portion of the PLC assets to a plurality of respective stations, and each station corresponds to a distinct work area within an industrial facility.

In a further embodiment of any of the foregoing embodiments, the method includes receiving at least one add-on instruction (“AOI”), each of the at least one AOIs including supplemental PLC logic, and creating PLC logic includes configuring the set of PLC ladder logic templates to invoke the at least one AOI.

In a further embodiment of any of the foregoing embodiments, creating PLC logic includes configuring the set of PLC templates to utilize a plurality of defined data types that are stored in the set of PLC templates.

In a further embodiment of any of the foregoing embodiments, the method includes outputting the PLC logic into one or more extensible markup language (XML) files.

A system according to an example embodiment of the present disclosure includes processing circuitry operatively connected to memory. The processing circuitry is configured to receive programmable logic controller (PLC) configuration data for an industrial process. The PLC configuration data describes a PLC, a plurality of PLC assets, a plurality of PLC devices associated with the plurality of PLC assets, and network connectivity data for communication between the PLC and the PLC assets and PLC devices. The processing circuitry is also configured to determine, from a repository of PLC ladder logic templates and based on the PLC configuration data, a set of PLC ladder logic templates that correspond to the plurality of PLC assets and PLC devices; and, based on the PLC configuration data and set of PLC ladder logic templates, create PLC logic for performance of the industrial process. The PLC logic includes the set of PLC ladder logic templates populated with portions of the PLC configuration data.

In a further embodiment of the foregoing embodiment, the processing circuitry is configured to provide a table-based interface to a user and receive the PLC configuration data through the table-based interface.

In a further embodiment of any of the foregoing embodiments, the table-based interface is a spreadsheet interface, and the processing circuitry is configured to provide the table-based interface through a spreadsheet editor.

In a further embodiment of any of the foregoing embodiments, the plurality of PLC assets includes at least one robot, and the PLC configuration data describes, for each of the at least one robots, an intended function of the robot and a sequence of the intended function in the industrial process.

In a further embodiment of any of the foregoing embodiments, the PLC configuration data includes a description of a plurality of slots of a chassis of the PLC, and, for each slot in a subset of the slots that are not empty, a device present in the slot.

In a further embodiment of any of the foregoing embodiments, the PLC configuration data includes, for each of the plurality of PLC devices, a type of the PLC device, a network address of the PLC device, a name of the PLC device, and an indication of which slot of a chassis of the PLC the network address corresponds to.

In a further embodiment of any of the foregoing embodiments, the PLC configuration data includes a description of an allocation of at least a portion of the PLC assets to a plurality of respective stations. Each station corresponds to a distinct work area within an industrial facility.

In a further embodiment of any of the foregoing embodiments, the processing circuitry is configured to receive at least one add-on instruction (“AOI”), each of the at least one AOIs including supplemental PLC logic; and, as part of creation of the PLC logic, configure the set of PLC ladder logic templates to invoke the at least one AOIS.

In a further embodiment of any of the foregoing embodiments, the processing circuitry is configured to, as part of creation of the PLC logic, configure the set of PLC templates to utilize a plurality of defined data types that are stored in the set of PLC templates.

In a further embodiment of any of the foregoing embodiments, the processing circuitry is configured to output the PLC logic into one or more extensible markup language (XML) files.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of an example PLC environment that includes a PLC.

FIG. 2A illustrates a PLC information table for the PLC environment of FIG. 1.

FIG. 2B illustrates a PLC chassis configuration table for the PLC environment of FIG. 1.

FIG. 3 illustrates a PLC zone and station information table for the PLC environment of FIG. 1.

FIG. 4 illustrates an I/O configuration data table for the PLC environment of FIG. 1.

FIG. 5A illustrates a table of example PLC types that may be used in the PLC environment of FIG. 1.

FIG. 5B illustrates a table of a table of example PLC chassis types that may be used in the PLC environment of FIG. 1.

FIG. 5C illustrates a table of example PLC devices that may be used in the PLC environment of FIG. 1.

FIG. 6A illustrates configuration data for a first robot in the PLC environment of FIG. 1.

FIG. 6B illustrates configuration data for a second robot in the PLC environment of FIG. 1.

FIG. 6C illustrates configuration data for a third robot in the PLC environment of FIG. 1.

FIG. 7 illustrates an example computer-implemented method for the automatic generation of PLC logic.

FIG. 8 illustrates an example computing device configured to perform the method of FIG. 7.

### DETAILED DESCRIPTION

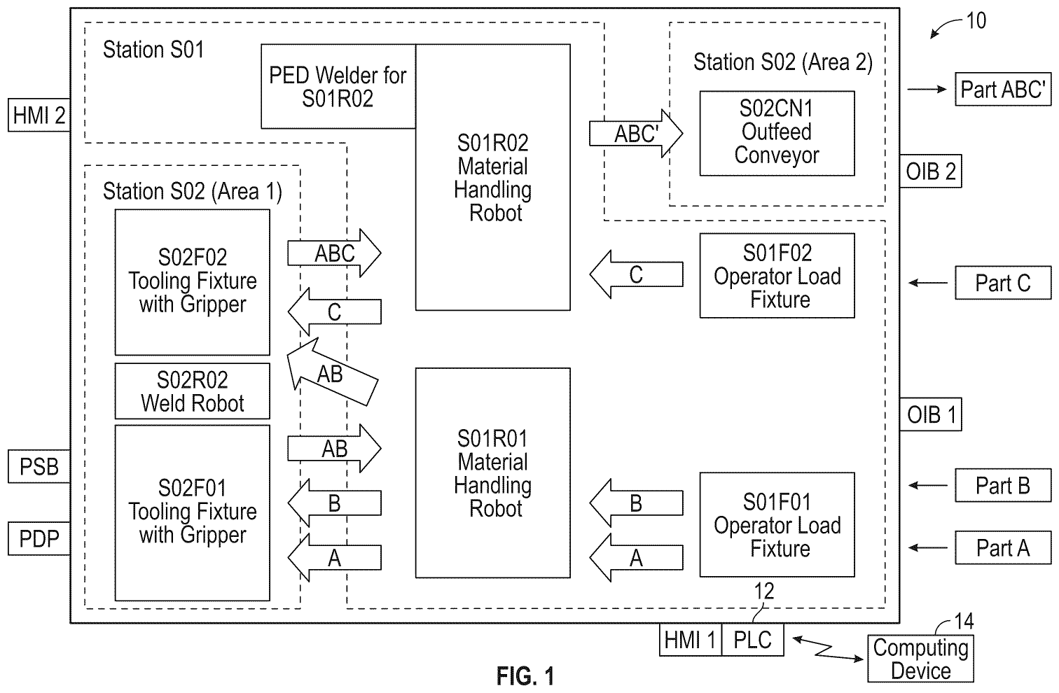

FIG. 1 is a schematic view of an example PLC environment 10 that includes a PLC 12 configured to control industrial machinery in a first station S01 and a second station S02 to perform an industrial manufacturing process, which in the non-limiting example of FIG. 1 is a welding process for welding two brackets to a roof header of an automobile. In the example of FIG. 1, the section station S02 includes a first area (“area 1”) and a second area (“area 2”). First, an overview of the example industrial process will be provided, then operation and configuration of the PLC 12 will be discussed.

To start the welding process, an operator loads Part A (a roof header) and Part B (a first bracket) into an operator load fixture S01F01 (with “S01” referring to the first station S01, and “F01” referring to a first fixture). The operator load fixture S01F01 provides Parts A and B to a material handling robot S01R01, which picks Parts A and B from S01F01, and provides them to tooling fixture S02F01, which is part of station S02.

Once S01R01 is sufficiently clear of a work area of tooling fixture S02F01, tooling fixture S02F01 closes its gripper clamp(s) on Parts A and B. With Parts A and B in a particular orientation and position, weld robot S02R02 welds Parts A and B together while Parts A and B are gripped by tooling fixture S02F01, resulting in combined Part AB. Once the weld is complete, robot S02F01 opens its clamps, and robot S01R01 picks the part AB from S02F01 and provides Part AB to tooling fixture S02F02.

The same or another operator loads Part C into operator load fixture S01F02, and material handling robot S01R02 picks Part C and provides Part C to tooling fixture S02F02. Once S01R02 is sufficiently clear of a work area of tooling fixture S02F02, tooling fixture S02F02 closes its gripper clamp(s) to grip Parts AB and C. With Parts AB and C in a particular orientation and position, weld robot S02R02 welds Parts AB and C together in S02F02, resulting in combined Part ABC.

Once the weld is complete, material handling robot S01R02 picks the part, and utilizes the depicted PED welder to provide an additional weld, resulting in part ABC′. Material handling robot S01R02 provides the part ABC′ to outfeed conveyor S02CN1, and the same or another operator takes the part ABC′ out of the outfeed conveyor S02CN1 and places it onto a storage rack (not shown).

In the realm of PLC, the term “PLC assets” refers to machinery configured to move, hold, or modify a component for an industrial process (e.g., robots, load fixtures, tooling fixtures, conveyors, turntables, and transfer systems such as conveyors or rollers), and the term “PLC devices” refers to devices configurable for connection to a PLC to support performance of the industrial process (e.g., valves, cameras, ethernet switches, power distribution panels, power supplies, etc.).

Within the PLC environment 10, each of the following items are considered PLC assets: operator load fixtures S01F01 and S01F02, tooling fixtures S02F01 and S02F02, material handling robots S01R01 and S01R02, weld robot S02R02, and outfeed conveyor S02CN1.

The PLC environment 10 also includes a plurality of PLC devices, including human-machine interface (“HMI”) A and HMI B, power distribution panel (PDP), power supply box (PSB), and operator interface box (“OIB”) 1 and OIB 2. HMI A and B provide user interfaces for, e.g., indicating a state of the various pieces of equipment in Stations 1 and 2. The power supply box PSB provides power, and the power distribution panel PDP provides one or more voltages that may differ from a voltage provided by the PSB. The operator interface boxes OIB 1 and OIB 2. OIB 1 and OIB 2 provide the capability for operators to start cycles in S01F01 and S01F02 when the parts A, B, and C are loaded in those operator load fixtures, and to stop the automatic process when an emergency stop button is pressed or operator light screens are violated (i.e., their associated barriers are crossed). Although not shown in FIG. 1, it is understood that various other PLC devices may be present in the PLC environment 10, such as valves (for controlling pneumatic actuators and power), ethernet switches, ethernet modules, and more. Although sensors (e.g., light screens) are also not shown, it is understood that they may be part of the PLC environment 10, and may be in communication with PLC devices or assets.

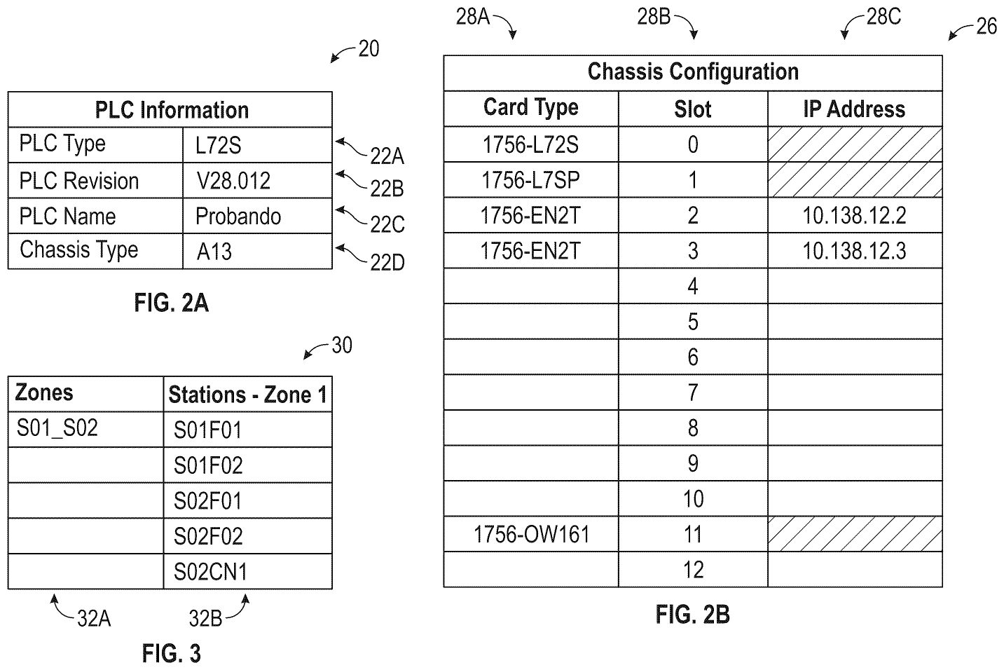

As will be discussed in greater detail below, a computing device 14 is configured to receive PLC configuration data for one or more PLC environments (e.g., PLC environment 10), and to automatically generate PLC logic for controlling those PLC environments. The PLC logic is provided as ladder logic. Example PLC configuration data in FIGS. 2A-B, 3, 4, 5C, and 6A-C will now be described for the PLC environment 10.

FIG. 2A illustrates a PLC information table 20 for the PLC environment 10 of FIG. 1 that indicates a PLC type 22A, PLC revision 22B, PLC name 22C, and PLC chassis type 22D.

FIG. 2B illustrates PLC chassis configuration table 26 for the PLC environment 10 of FIG. 1 that indicates a configuration of the various input/output slots of the PLC 12 cards. The table 26 includes a card type column 28A, a slot number column 28B, and an IP address column 28C. As shown, cards are present in slots 0-3 and 11, but not in slots 0-1 and 11.

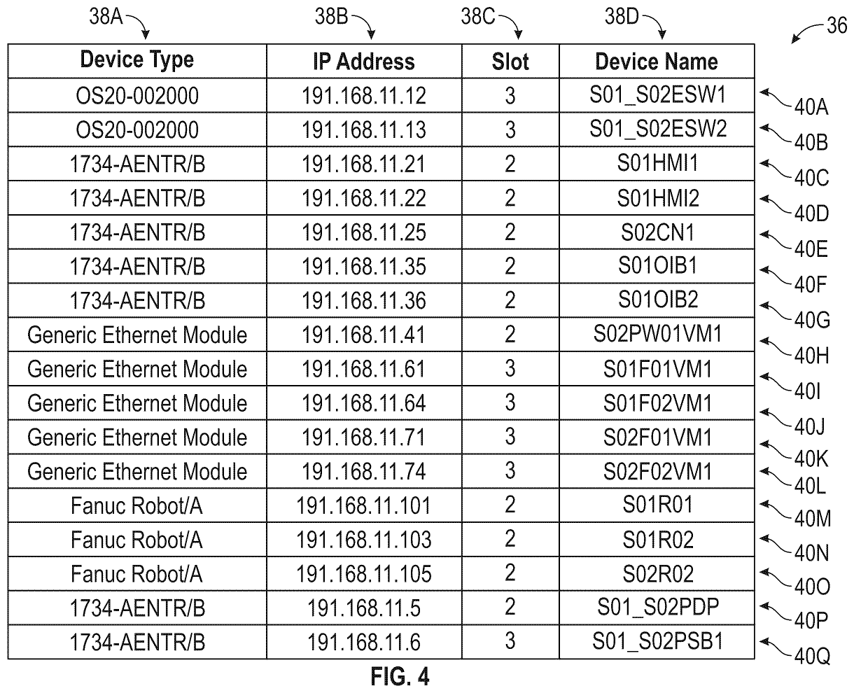

FIG. 3 illustrates a PLC zone and station information table 30 for the PLC environment 10 of FIG. 1. The table 30 includes a column 32A describing the zones of the PLC environment 10, and how only a single zone S01_S02 is included in the PLC environment 10. Column 32B provides a list of non-robot PLC assets, which include the operator load fixtures S01F02 and S01F02, the tooling fixtures S02F01 and S02F02, and the outfeed conveyor S02CN1.

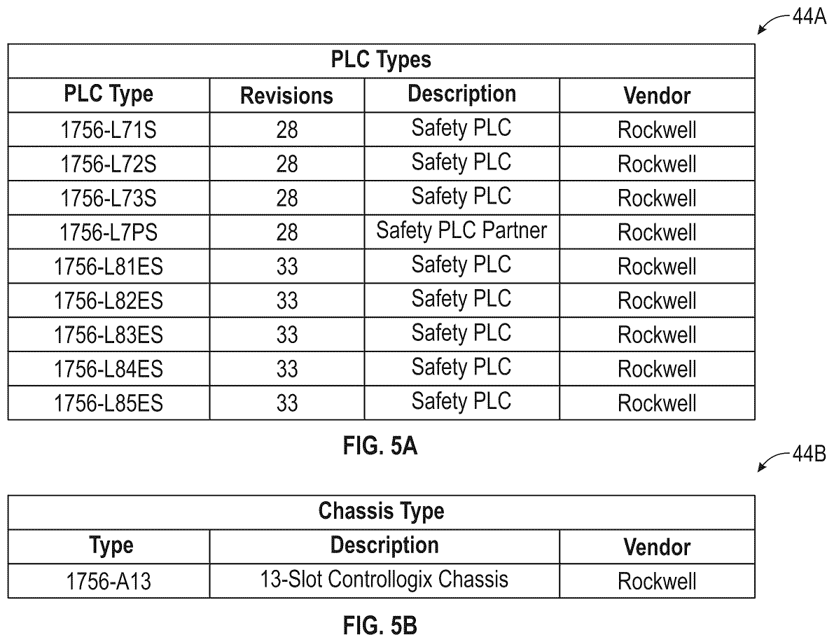

FIG. 4 illustrates an I/O configuration data table 36 for the PLC environment 10 of FIG. 1. The table 36 includes a device type column 38A, IP address column 38B, slot number column 38C, and device name column 38D, and provides information to enable the PLC 12 to communicate with the various PLC devices (ethernet switches, ethernet modules, HMIs, etc.) and PLC assets (robots) listed in the table 36. The slot number column 38C indicates which slot of the PLC 12 that the device described in a particular row is configured to communicate with. In the table 36, rows 40A-B describe ethernet switches, rows 40C-D describe HMI1 and HMI2 in FIG. 1, row 40E describes the conveyor S02CN1, rows 40F-G describe OIB 1 and OIB 2 in FIG. 1, rows 40H-L describe ethernet modules that are distributed throughout the PLC environment 10, rows 40M-400 describe robots S01R01, S01R02, and S02R02, row 40P describes the PDP of FIG. 1, and row 40Q describes the PSB of FIG. 1.

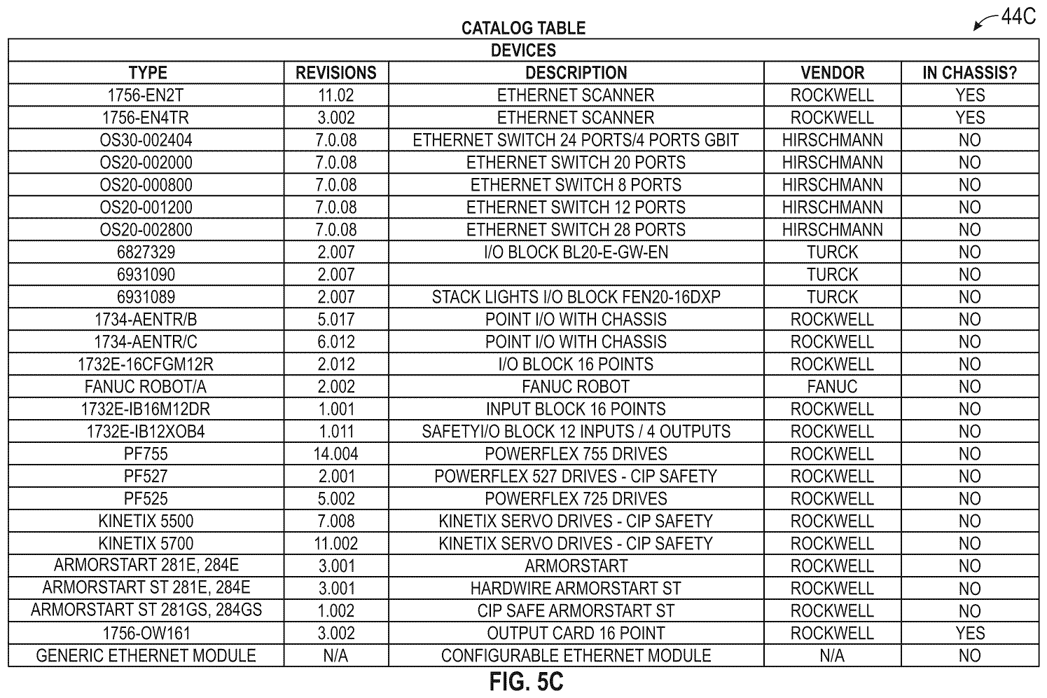

FIG. 5A-C illustrate catalog tables 44A-C that each list items that can be used in the PLC environment 10 of FIG. 1. FIG. 5A illustrates a table 44A of example PLC types that may be used in the PLC environment 10 of FIG. 1. FIG. 5B illustrates a table 44B of example PLC chassis types that may be used in the PLC environment 10 of FIG. 1. FIG. 5C illustrates a table 44C of example PLC devices that may be used in the PLC environment 10 of FIG. 1. Table 44C also includes an “In Chassis?” column that indicates whether a particular PLC device is in the chassis of PLC 12. Thus, table 44C, while providing catalog data, also provides PLC configuration data. Tables 44A-B meanwhile, as catalogs, essentially indicate potential PLC configuration data that may or may not be used in the PLC environment 10. It is understood that the items listed in the tables 44A-C are only examples, and that other items could be listed.

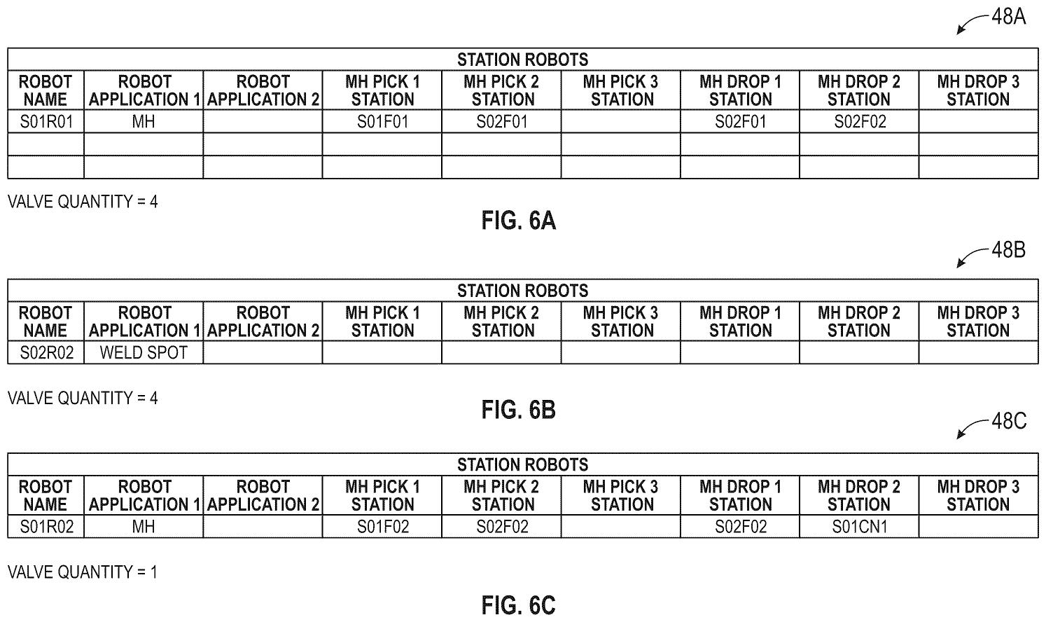

FIG. 6A-C illustrate tables 48A-C of robot configuration data for the PLC environment 10 of FIG. 1. Although spread across three tables, it is understood that the data of the tables 48A-C could be combined into fewer tables if desired.

FIG. 6A illustrates a table 48A of configuration data for material handling robot S01R01. As described in the table 48A, the robot S01R01 is a material handling robot (as indicated by acronym “MH” in the “Robot Application 1” column), which picks parts first from S01F01 (Part A and Part B) and from S02F01 (combined Part AB), and “drops” parts at S02F01 (Part A and Part B separately) and at S02F02 (combined Part AB). Also, as shown in the table 48A, the material handling robot S01R01 uses four pneumatic valves.

FIG. 6B illustrates a table 48B of configuration data for weld robot S02R02. As described in the table 48B, the robot S02R02 is a weld spot robot (as indicated by the descriptor “Weld Spot” in the “Robot Application 1” column. Also, as shown in the table 48B, the weld robot S01R01 uses four pneumatic valves.

FIG. 6C illustrates a table 48C of configuration data for material handling robot S01R02. As described in the table 48C, the robot S01R02 is a material handling robot (as indicated by acronym “MH” in the “Robot Application 1” column), which picks parts first from S01F01 (Part C) and from S02F02 (combined Part ABC), and “drops” parts at S02F02 (Part C) and at S01CN1 (combined Part ABC′). Also, as shown in the table 48C, the material handling robot S01R02 uses one pneumatic valve.

In one or more embodiments, the non-catalog tables in FIGS. 2A-B, 3, 4, and 6A-C include drop-down menus in certain cells for selection of predefined items from the catalog tables 44A-C of FIGS. 5A-C.

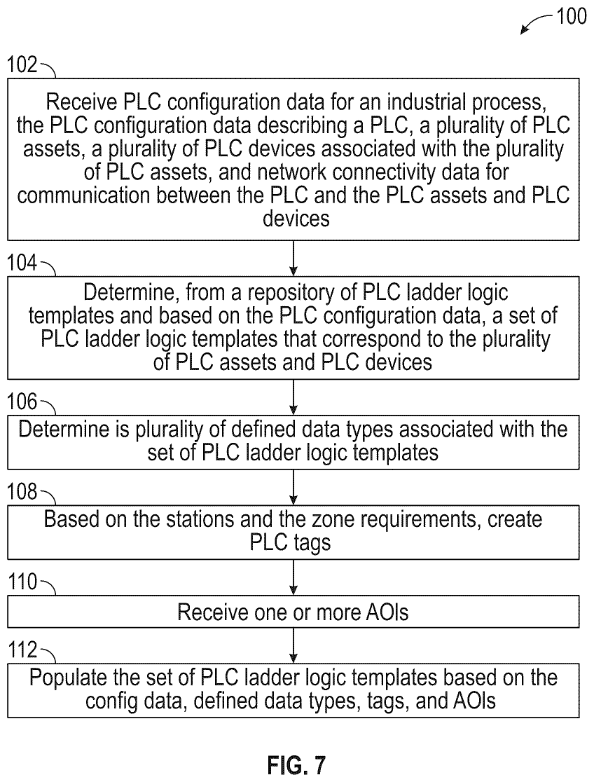

FIG. 7 illustrates an example computer-implemented method 100 for the automatic generation of PLC logic. The method 100 may be performed by computing device 14 of FIG. 1, for example.

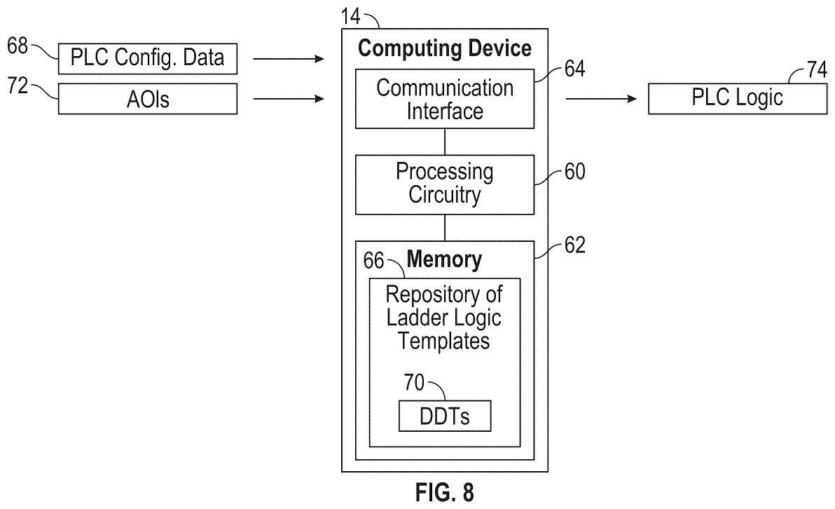

FIG. 8 illustrates the computing device 14 of FIG. 1 in greater detail.

Referring now to FIGS. 7 and 8 together, PLC configuration data 68 (see FIG. 8) for an industrial process is received (e.g., from a user) (step 102). Example PLC configuration data 68 is provided in FIGS. 2A-B, 3, 4, 5C, and 6A-C. Although a manufacturing/welding industrial process is described above, it is understood that the method could be utilized to generate PLC logic for any industrial process (e.g., those in the fields of food processing, mining, and pharmaceutical processing, etc.).

The PLC configuration data 68 received in step 102 describes the PLC 12 (see, e.g., FIGS. 2A-B), a plurality of PLC assets (e.g., the robots S01R01, S02R01, and S02R02 and fixtures S01F01, S01F02, S02F01, S02F02, and S02CN1), a plurality of PLC devices associated with the plurality of PLC assets (see, e.g., the various non-robot devices listed in FIG. 4), and network connectivity data for communication between the PLC and the PLC assets and PLC devices (see, e.g., the IP addresses and PLC chassis slots described in FIG. 4).

The computing device 14 determines, from a repository 66 of PLC ladder logic templates (see FIG. 8) and based on the PLC configuration data 68, a set of PLC ladder logic templates that correspond to the plurality of PLC assets and PLC devices in the PLC configuration data 68 (step 104). The PLC ladder logic templates may include a plurality of main routines, and a plurality of subroutines that are called by the plurality of main routines, for example.

The computing device 14 determines a plurality of defined data types (“DDTs”) associated with the set of PLC ladder logic templates (step 106). The DDTs are identified with reference numeral 70 in FIG. 8. In the realm of computer programming, it is known to categorize data using various data types, such as integers, floating point numbers, Boolean values, and strings. PLC technology takes this convention further, as PLC technology defines standardized names for single and double integers, signed and unsigned integers, timers, counters, strings, and also, a data type that is made up of custom combinations of the above data types called a “user-defined type”, or a UDT. Within a UDT, various bits in a larger value may be assigned to different parameters. The use of UDTs is common in PLC programming. In step 106, the term “DDTs” is used because the defined data types may not necessarily be defined by a user interacting with the computing device 14, however, the PLC 12 would consider them to be UDTs, and would treat them as UDTs (regardless of who defined them).

Based on station and zone requirement described in the PLC configuration data 68 (see, e.g., FIG. 3 and FIGS. 6A-C) and the plurality of DDTs determined in step 106, the computing device 14 creates PLC tags (step 108), which are analogous to data structures for the PLC 12 to communicate with its associated assets and devices. In one or more examples, the DDTs are used as the body of one or more of the tags. The DDTs may also include some internal PLC logic.

Optionally, the computing device 14 receives at least one add-on instruction statements (AOI) which includes supplemental PLC logic (step 110). An AOI is basically a function defined by a programmer that works in the same manner as the one provided by the manufacturer of the PLC 12, to augment the native “off the shelf” functionality provided by the PLC 12.

Based on the PLC configuration data 68, determined set of PLC ladder logic templates, DDTs 70, and AOIs 72, and tags, the computing device 12 creates PLC logic 74 for performance of the industrial process (step 112). The PLC logic 74 that is created includes the determined set of PLC ladder logic templates populated with portions of the PLC configuration data 68, the PLC tags of step 108, and the DDTs 70 of step 106. The PLC logic 74 is configured to invoke the one or more AOIs 72.

Once the PLC logic 74 is tested, it may be loaded into memory of the PLC 12 for performing the industrial process.

Although the steps of the method 100 are illustrated in a particular order in FIG. 7, it is understood that this is a non-limiting example, and that some of the steps could be performed in a different order (e.g., receive AOIs before step 106, or receive the UDTs after step 106).

In one or more embodiments, receiving the PLC configuration data in step 102 includes providing a table-based interface to a user, and receiving the PLC configuration data through the table-based interface. In one or more embodiments, the table-based interface is a spreadsheet interface, and providing the table-based interface includes through a spreadsheet editor (e.g., MICROSOFT EXCEL).

FIG. 8 illustrates an example computing device 14 (also shown in FIG. 1) that is configured to perform the method 100 of FIG. 7. The computing device 14 includes processing circuitry 60 operatively connected to memory 62 and a communication interface 64. The processing circuitry 60 include one or more microprocessors, microcontrollers, application specific integrated circuits (ASICs), or the like. The processing circuitry 60 is configured to perform the method 100 of FIG. 7.

The memory 62 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 62 may incorporate electronic, magnetic, optical, and/or other types of storage media. The memory 62 can also have a distributed architecture, where various components are situated remotely from one another, but can be accessed by the processing circuitry 60. The memory 62 stores the repository 66 of ladder logic templates that describe various ladder logic routines (e.g., main routines and associated subroutines).

The communication interface 64 is configured to facilitate communication between the computing device 14 and other computing devices, such as PLC 12, and/or a computing device of a user seeking to configure the PLC 12. The communication interface 64 may be configured for wired or wireless communication, for example.

Through the communication interface 64, the computing device 14 receives the PLC configuration data 68, and optionally also receives the UDTs 70, and AOIs 72. The computing device 14 utilizes those inputs and the repository 66 of ladder logic templates to perform the method 100 and output the PLC logic 74. The PLC logic 74 may be output in one or more extensible markup language (XML) files, for example.

In one or more embodiments, the plurality of PLC assets described in the PLC configuration data 68 include at least one robot, and the PLC configuration data 68 describes, for each of the at least one robots, an intended function of the robot and a sequence of the intended function in the industrial process (e.g., as shown in FIGS. 6A-C).

In one or more embodiments, the PLC configuration data 68 includes a description of a plurality of slots of the chassis of the PLC 12, and for each slot in a subset of the slots that are not empty, a device present in the slot (see, e.g., FIG. 2A-B).

In one or more embodiments, the PLC configuration data 68 includes, for each of the plurality of PLC devices, a type of the PLC device, a network address of the PLC device, a name of the PLC device, and an indication of which slot of the PLC chassis the network address corresponds to (see, e.g., FIG. 4).

In one or more embodiments, the PLC configuration data 68 includes a description of an allocation of at least a portion of the PLC assets to a plurality of respective stations (see, e.g., FIG. 3), where each station corresponds to a distinct work area within an industrial facility (see, e.g., FIG. 1). Although only one zone is described in FIG. 3, it is understood that any number of zones could be utilized.

It is understood that the PLC 12 could have a similar architecture to computing device 14, in that the PLC 12 includes processing circuitry 60, memory 62, and a communication interface 64, and that in the case of the PLC 12 a plurality of slots configured to receive various devices (e.g., as described in FIG. 2B).

In one or more embodiments, a user may wish to be able to perform industrial processes for different original equipment manufacturers (“OEMs”), such as automobile manufacturers, and each OEM may have their own way of formatting PLC logic (e.g., different names for things, different syntax, different PLC ladder logic templates, etc.). In one or more embodiments, the computing device 14 stores different repositories of ladder logic templates for different OEMs, allows a user to select which OEM they wish to generate PLC logic for, and then selects the ladder logic templates corresponding to the selected OEM to generate PLC logic 74 for that OEM.

The method and system described herein provide a number of benefits over the prior art, by automating and significantly expediting the process for creating PLC logic, while simultaneously avoiding errors that may otherwise occur during the ordinary course of programming PLC logic.

Developing a PLC file typically takes about 12 weeks (approximately 1,200 hours of labor), but by utilizing the techniques discussed herein, it is estimated that this could be reduced to 5 weeks (on the order of a 60% reduction in PLC development time with a similar corresponding reduction in hours of labor). In addition to reducing hours of labor and cost, the techniques discussed herein may be used to produce high-quality and error-free PLC logic in a versatile manner that is applicable to a wide variety of industries. The techniques discussed herein are also very versatile and adaptable, as users are given an opportunity to utilize their own AOIs. The techniques discussed herein also facilitate the standardization of PLC logic, potentially ensuring that various suppliers of an OEM will follow the same standard PLC logic format.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A computer-implemented method, comprising:
receiving programmable logic controller (PLC) configuration data for an industrial process, the PLC configuration data describing a PLC, a plurality of PLC assets, a plurality of PLC devices associated with the plurality of PLC assets, and network connectivity data for communication between the PLC and the PLC assets and PLC devices;
determining, from a repository of PLC ladder logic templates and based on the PLC configuration data, a set of PLC ladder logic templates that correspond to the plurality of PLC assets and PLC devices; and
based on the PLC configuration data and set of PLC ladder logic templates, creating PLC logic for performance of the industrial process, the PLC logic including the set of PLC ladder logic templates populated with portions of the PLC configuration data.

2. The computer-implemented method of claim 1, wherein said receiving comprises:
providing a table-based interface to a user; and
receiving the PLC configuration data through the table-based interface.

3. The computer-implemented method of claim 2, wherein:
the table-based interface is a spreadsheet interface; and
said providing the table-based interface comprises providing the table-based interface through a spreadsheet editor.

4. The computer-implemented method of claim 1, wherein:
the plurality of PLC assets includes at least one robot; and
the PLC configuration data describes, for each of the at least one robots, an intended function of the robot and a sequence of the intended function in the industrial process.

5. The computer-implemented method of claim 1, wherein the PLC configuration data includes a description of a plurality of slots of a chassis of the PLC, and, for each slot in a subset of the slots that are not empty, a device present in the slot.

6. The computer-implemented method of claim 1, wherein the PLC configuration data includes, for each of the plurality of PLC devices, a type of the PLC device, a network address of the PLC device, a name of the PLC device, and an indication of which slot of a chassis of the PLC the network address corresponds to.

7. The computer-implemented method of claim 1, wherein:
the PLC configuration data includes a description of an allocation of at least a portion of the PLC assets to a plurality of respective stations; and
each station corresponds to a distinct work area within an industrial facility.

8. The computer-implemented method of claim 1, comprising:
receiving at least one add-on instruction (“AOI”), each of the at least one AOIs including supplemental PLC logic;
wherein said creating PLC logic comprises configuring the set of PLC ladder logic templates to invoke the at least one AOI.

9. The computer-implemented method of claim 1,
wherein said creating PLC logic comprises configuring the set of PLC templates to utilize a plurality of defined data types that are stored in the set of PLC templates.

10. The computer-implemented method of claim 1, comprising:
outputting the PLC logic into one or more extensible markup language (XML) files.

11. A system, comprising:
processing circuitry operatively connected to memory and configured to:
receive programmable logic controller (PLC) configuration data for an industrial process, the PLC configuration data describing a PLC, a plurality of PLC assets, a plurality of PLC devices associated with the plurality of PLC assets, and network connectivity data for communication between the PLC and the PLC assets and PLC devices;
determine, from a repository of PLC ladder logic templates and based on the PLC configuration data, a set of PLC ladder logic templates that correspond to the plurality of PLC assets and PLC devices; and
based on the PLC configuration data and set of PLC ladder logic templates, create PLC logic for performance of the industrial process, the PLC logic including the set of PLC ladder logic templates populated with portions of the PLC configuration data.

12. The system of claim 11, wherein the processing circuitry is configured to:
provide a table-based interface to a user; and
receive the PLC configuration data through the table-based interface.

13. The system of claim 12, wherein:
the table-based interface is a spreadsheet interface; and
the processing circuitry is configured to provide the table-based interface comprises through a spreadsheet editor.

14. The system of claim 11, wherein:
the plurality of PLC assets includes at least one robot; and
the PLC configuration data describes, for each of the at least one robots, an intended function of the robot and a sequence of the intended function in the industrial process.

15. The system of claim 11, wherein the PLC configuration data includes a description of a plurality of slots of a chassis of the PLC, and, for each slot in a subset of the slots that are not empty, a device present in the slot.

16. The system of claim 11, wherein the PLC configuration data includes, for each of the plurality of PLC devices, a type of the PLC device, a network address of the PLC device, a name of the PLC device, and an indication of which slot of a chassis of the PLC the network address corresponds to.

17. The system of claim 11, wherein:
the PLC configuration data includes a description of an allocation of at least a portion of the PLC assets to a plurality of respective stations; and
each station corresponds to a distinct work area within an industrial facility.

18. The system of claim 11, wherein the processing circuitry is configured to:
receive at least one add-on instruction (“AOI”), each of the at least one AOIs including supplemental PLC logic; and
as part of creation of the PLC logic, configure the set of PLC ladder logic templates to invoke the at least one AOIS.

19. The system of claim 11, wherein the processing circuitry is configured to:
as part of creation of the PLC logic, configure the set of PLC templates to utilize a plurality of defined data types that are stored in the set of PLC templates.

20. The system of claim 11, wherein the processing circuitry is configured to:
output the PLC logic into one or more extensible markup language (XML) files.
